(19) United States
(12) Patent Application Publication
(10) Pub. No.: US 2014/0072890 A1
(43) Pub. Date: Mar. 13, 2014

(54) FUEL CELL POWER GENERATION SYSTEM WITH OXYGEN INLET INSTEAD OF AIR

(71) Applicant: YUAN ZE UNIVERSITY, (US)

(72) Inventors: GUO-BIN JUNG, TAOYUAN COUNTY (TW); TING-CHU JAO, TAOYUAN COUNTY (TW); SHIH-HUNG CHAN, TAOYAUN COUNTY (TW); WEI-JEN TZENG, TAOYUAN COUNTY (TW); YU-HSU LIU, HSINCHU COUNTY (TW)

(73) Assignee: YUAN ZE UNIVERSITY, TAOYUAN COUNTY (TW)

(21) Appl. No.: 13/726,136

(22) Filed: Dec. 23, 2012

(30) Foreign Application Priority Data
Sep. 12, 2012 (TW) 101133324

(51) Int. Cl. H01M 8/06

(52) U.S. Cl. CPC H01M 8/0662
USPC 429/422

(57) ABSTRACT

This instant disclosure provides a fuel cell power generation system including a PSA (pressure swing adsorption) oxygen generator, an hydrogen device and a fuel cell device. The PSA oxygen generator has an oxygen storing unit for storing oxygen, and the PSA oxygen generator is for generating oxygen. The hydrogen device has a hydrogen storing unit for storing hydrogen, and the electrolysis and catalysis is for generating hydrogen. The fuel cell device is connected to the PSA oxygen generator and the hydrogen device to make electrochemical reaction of oxygen generated from the PSA oxygen generator and the hydrogen generated from the hydrogen device for outputting electrical power.

### BACKGROUND OF THE INVENTION

1. Field of the Invention

The instant disclosure relates to a fuel cell; in particular, to a fuel cell power generation system.

2. Description of Related Art

A fuel cell is a high efficiency and clean power. The fuel cell is able to directly convert the chemical energy of various fuels, such as alcohol, natural gas or hydrogen, to the electrical power by the oxidized and reduced manner. The fuel cell becomes a burgeoning and popular power generating device, because it has the characteristics of the high energy conversion efficiency and the low environmental pollution. The hydrogen-oxygen fuel cell utilizes the hydrogen and oxygen as the fuel and oxidant and the by-product is just water. The hydrogen-oxygen fuel cell usually has proton exchange membrane (PEM) as electrolyte, so it also called proton exchange membrane fuel cell.

Reference to FIG. 1, FIG. 1 is a schematic diagram of a conventional proton exchange membrane fuel cell. The proton exchange membrane fuel cell 1 comprises an anode 11, a cathode 12 and a proton exchange membrane 14. A load 13 is connected to the anode 11 and the cathode 12 in order to constitute a closed loop. Hydrogen (H₂) is able to generate electrons through the oxidation reaction at the anode 11, and the generated electrons are transferred to the cathode 12 through the load 13. The cathode 12 utilizes the oxygen in the air and the electrons received by the closed loop to operate reduction reaction. Although the fuel cell has been widely used, the production of new fuel cells and the associated power generation system is still an important subject for the skilled in the art.

### SUMMARY OF THE INVENTION

The object of the instant disclosure is to offer a fuel cell power generation system, utilizing the pure oxygen generated by the PSA (Pressure Swing Adsorption) oxygen generator to replace the air, and utilizing the pure oxygen to as the oxidant source when the fuel cell device is generating electric power. Accordingly, the power generation efficiency could be improved.

In order to achieve the aforementioned objects, according to an embodiment of the instant disclosure, a fuel cell power generation system is offered. The fuel cell power generation system comprises a pressure swing adsorption (PSA) oxygen generator, an electrolysis device, a reformer and a fuel cell device. The pressure swing adsorption (PSA) oxygen generator generates the oxygen and has an oxygen storing unit to store the generated oxygen. The electrolysis device (or reformer) generates hydrogen and has a hydrogen storing unit to store the generated hydrogen. The fuel cell device connected to the PSA oxygen generator and the electrolysis device. The fuel cell device makes the reaction of the oxygen generated by the PSA oxygen generator and the hydrogen generated by the hydrogen storing unit to generate electrical power.

In order to achieve the aforementioned objects, according to an embodiment of the instant disclosure, a fuel cell power generation system is offered. The fuel cell power generation system comprises a pressure swing adsorption (PSA) oxygen generator, a hydrogen storing unit, an oxygen storing unit and a fuel cell device. The pressure swing adsorption (PSA) oxygen generator generates the oxygen. The fuel cell device is connected to the PSA oxygen generator, the hydrogen storing unit and the oxygen storing unit. The fuel cell device operates in a first mode or a second mode. When the fuel cell device operates in the first mode, the fuel cell device receives electrical power of a power source to electrolyze water to generate hydrogen, and stores the generated hydrogen in the hydrogen storing unit. When the fuel cell device operates in the second mode, the fuel cell device generates electrical power by making the reaction of the oxygen generated from the PSA oxygen generator or the oxygen storing unit and the hydrogen released from hydrogen storing unit.

To sum up, a fuel cell power generation system utilizes the oxygen generated by the PSA oxygen generator to replace the air, and the output electrical power of the fuel cell can be effectively enhanced. Meanwhile, the enhanced output electrical power of the fuel cell is greater than the power consumed by the PSA oxygen generator, thus the efficiency of the overall power generation of the fuel cell generation system can be improved.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a schematic diagram of a conventional proton exchange membrane fuel cell;

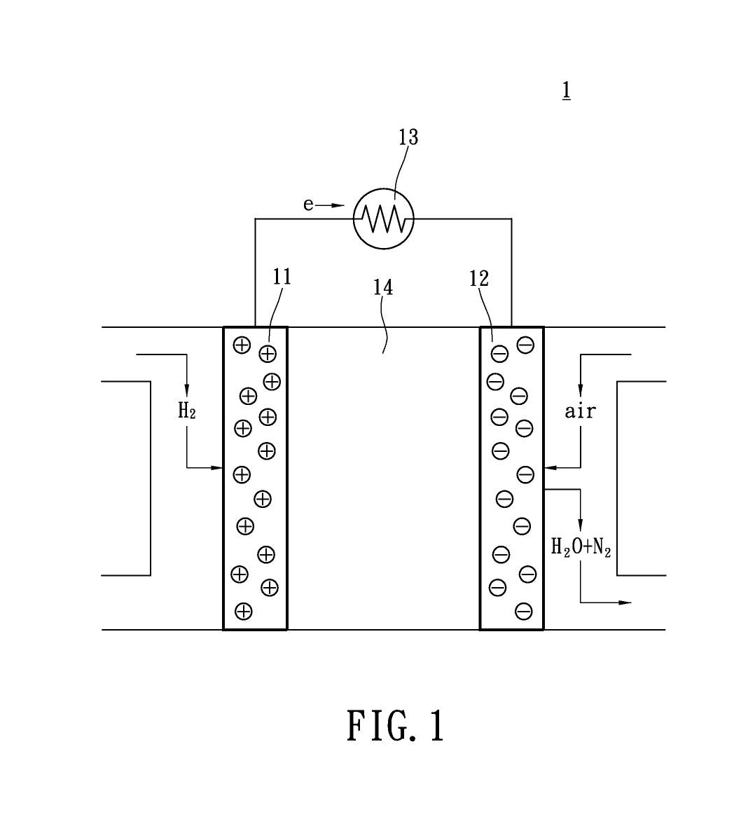

FIG. 2 shows a block diagram of a fuel cell power generation system according to an embodiment of the instant disclosure;

FIG. 3A shows a detailed block diagram of a fuel cell power generation system according to an embodiment of the instant disclosure;

FIG. 3B shows an experimental curve diagram of voltage versus current density of the fuel cell device according to an embodiment of the instant disclosure;

FIG. 4 shows a block diagram of a fuel cell power generation system according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

This instant disclosure discloses a fuel cell power generation system, utilizing the pure oxygen generated by the PSA oxygen generator to replace the air, and utilizing the pure oxygen to as the oxidant source when the fuel cell device is generating electric power. In the following paragraphs of the instant disclosure, improved power generation efficiency could be carried out when using pure oxygen to be the oxidant source for the fuel cell device. The power consumption for the PSA oxygen generator to generate pure oxygen is less than the increased power output of the fuel cell device. Therefore, the overall power generation efficiency of the fuel cell power generation system could be improved.

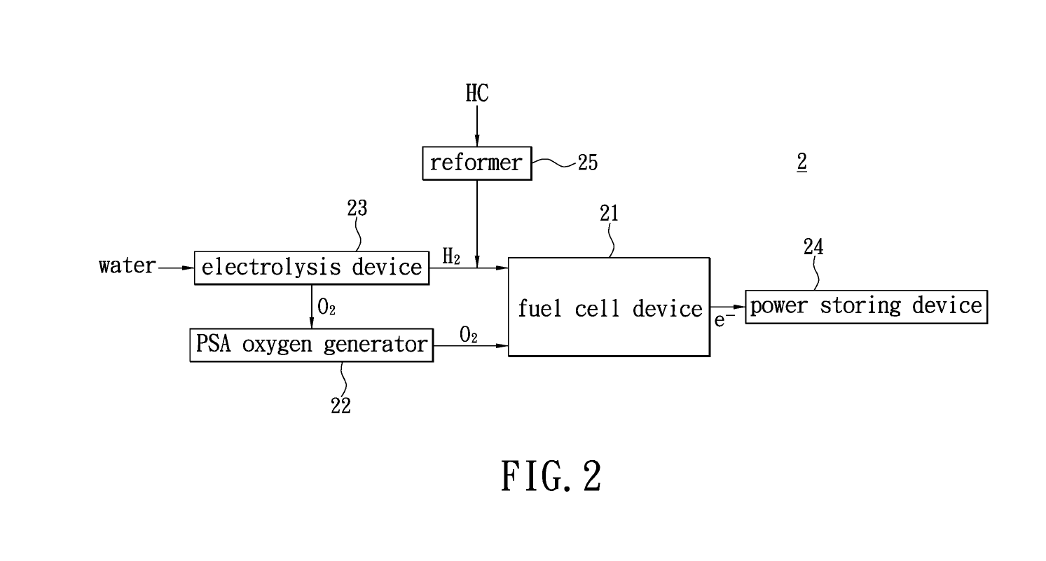

Reference to FIG. 2, FIG. 2 shows a block diagram of a fuel cell power generation system according to an embodiment of the instant disclosure. The fuel cell power generation system 2 showed in FIG. 2 merely introduces the inventive concepts of the instant invention, in the subsequent embodiment and the drawings will further disclosure the detail elements of the fuel cell generation system. The fuel cell power generation system 2 comprises a pressure swing adsorption (PSA) oxygen generator 22, an electrolysis device 23, a reformer device 25 and a fuel cell device 21. The pressure swing adsorption (PSA) oxygen generator 22 generates the oxygen and has an oxygen storing unit to store the generated oxygen. The electrolysis device 23 (or reformer device 25) generates hydrogen and has a hydrogen storing unit to store the generated hydrogen.

The fuel cell device 21 connected to the PSA oxygen generator 22 and the electrolysis device 23 (or reformer device 25), the fuel cell device makes the reaction of the oxygen generated by the PSA oxygen generator 22 and the hydrogen generated by the electrolysis device 23 (or reformer device 24) to generate electrical power.

The electrolysis device 23 electrolyze water to generate hydrogen. The reformer device 25 catalyze hydrocarbon species (ex. methanol, natural gas, . . .) to generate hydrogen. The fuel cell device 21 may utilize the proton exchange membrane (PEM) fuel cell 1 to make reaction of hydrogen and oxygen for generating electrical power. The electrolysis device 23 is not restricted thereto.

The electrolysis device 23 may be different in types. For example, the electrolysis device 23 may utilize proton exchange membrane water electrolysis, alkaline electrolysis, phosphoric acid electrolysis, carbonate molten salt electrolysis, solid oxide electrolysis, or any combination thereof. As long as the electrolysis device 23 could generate hydrogen.

The PSA oxygen generator uses the pressure swing adsorption technique to extract the oxygen in the air for obtaining high concentration of oxygen. Basically, the pressure swing adsorption technique is a gas separation technology, in which an adsorbent (e.g. porous solid material) is used usually. The inner surface of the adsorbent is used to make physical adsorption for the gas molecules, thus the different gas molecules could be separated. The physical adsorption usually includes cycling process with pressurized adsorption and vacuum adsorption. One embodiment of the pressure swing adsorption is use molecular sieve (e.g. Zeolite molecular sieve (ZMS) or Lithium molecular sieve) to adsorb nitrogen of the air, meanwhile, the amount of oxygen in the air adsorbed to the molecular sieve is quite less. Thus, the proportion of the nitrogen in the air is significantly reduced, and the proportion of the oxygen in the air is greatly increased. Accordingly, the high concentration oxygen could be made. Additionally, the adsorbent may be recycled by using atmospheric desorption or vacuum pumping. The PSA oxygen generator 22 may utilize pressurized adsorption (in which the pressure varies from 0.2 MPa to 0.6 MPa) and atmospheric pressure desorption, thus the cost of the machine is less, the process is more simple, and adapted for the oxygen generator occasions of small-scale. For the oxygen generator occasions of large-scale, the PSA oxygen generator may utilize atmospheric pressure adsorption (or with pressure a little larger than atmospheric pressure (less than 50 KPa)) and vacuum desorption, meanwhile, the machine is more complicated and the efficiency is higher and the power consumption per generating unit is less. However, the above-mentioned examples is only for conveniently explaining the principle of the PSA oxygen generator, the instant disclosure does not limited the generating oxygen method of the exemplary embodiment of the PSA oxygen generator 22 in FIG. 2 and other exemplary embodiments of the PSA oxygen generator.

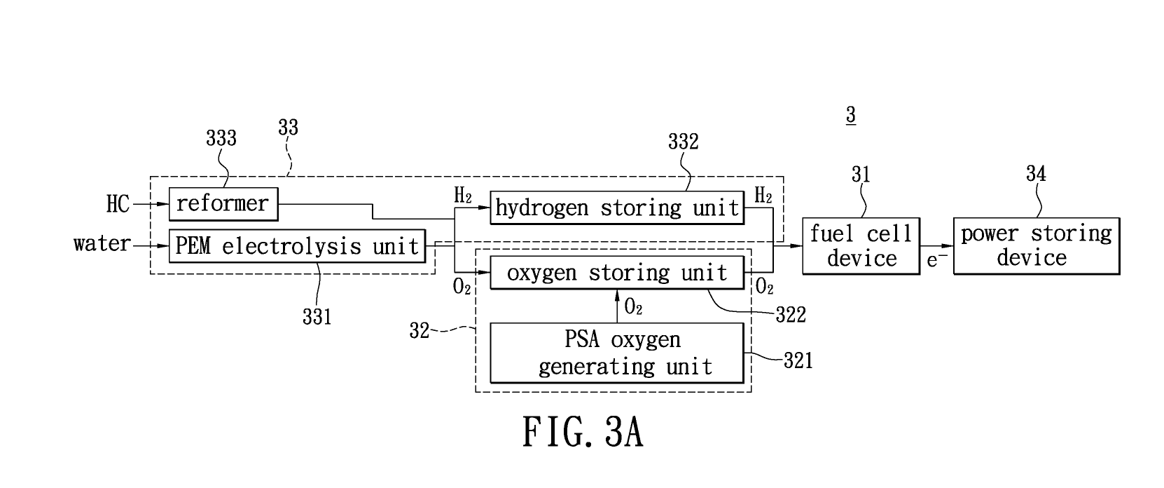

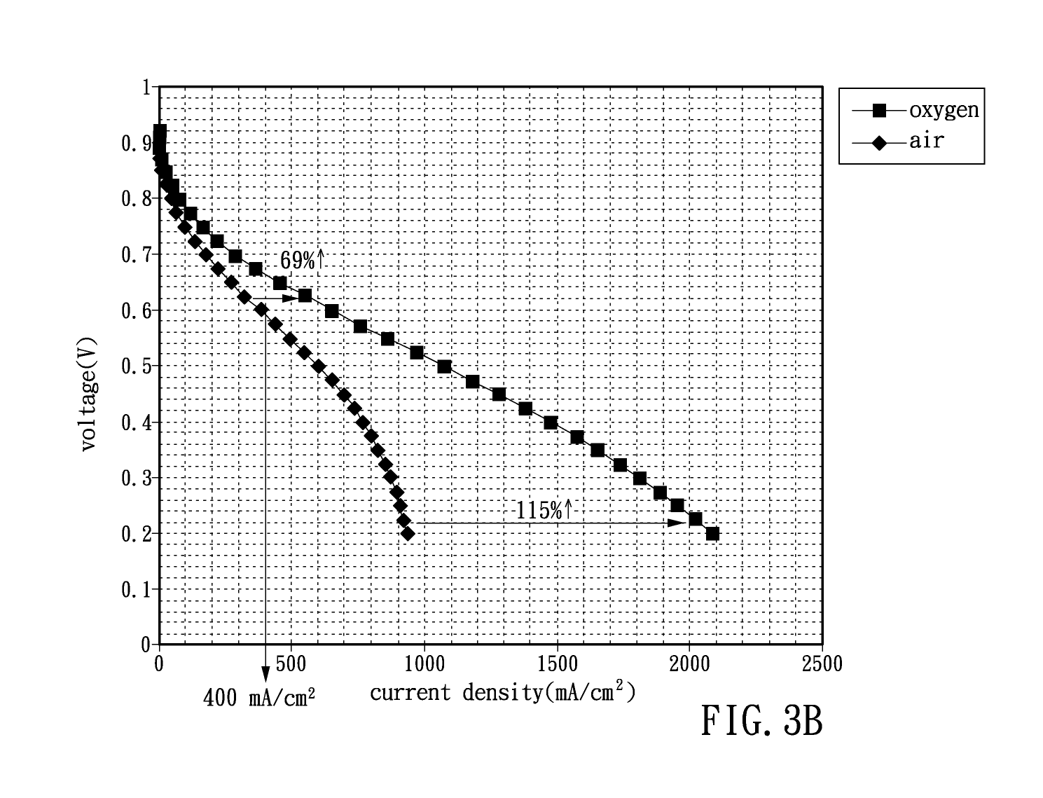

Reference to FIG. 2 and FIG. 3A, FIG. 3A shows a detailed block diagram of a fuel cell power generation system according to an embodiment of the instant disclosure. The fuel cell power generation system 3 comprises a pressure swing adsorption (PSA) oxygen generator 32, an electrolysis device 33, a fuel cell device 31 and a power storage device 34. The pressure swing adsorption (PSA) oxygen generator 32 has a pressure swing adsorption (PSA) oxygen generation unit 321 and an oxygen storing unit 322. The hydrogen device 33 has a proton exchange membrane electrolysis unit 331 or a reformer 333 and a hydrogen storing unit 332. The fuel cell device 31 can be a proton exchange membrane fuel cell, an alkaline fuel cell, a phosphoric acid fuel cell, a carbonate molten salt fuel cell, a solid oxide fuel cell, or any combination thereof

The fuel cell device 31 connected to the PSA oxygen generator 32 and the hydrogen device 33, the fuel cell device 31 is used for making the reaction of the oxygen generated by the PSA oxygen generator 32 and the hydrogen generated by the hydrogen device 33 to generate electrical power. The proton exchange membrane electrolysis unit 331 or reformer 333 of the hydrogen device 33 is used to produce hydrogen, and the hydrogen storing unit 332 is for storing hydrogen. The pressure swing adsorption (PSA) oxygen generation unit 321 of the PSA oxygen generator 32 is used to produce oxygen, and the oxygen storing unit 322 is used to store the oxygen generated by the pressure swing adsorption (PSA) oxygen generation unit 321.

The proton exchange membrane (PEM) electrolysis unit 331 electrolyzes water to generate the hydrogen (H₂) and oxygen (O₂), and then the generated hydrogen (H₂) and oxygen (O₂) is transmitted to the hydrogen storing unit 332 and the oxygen storing unit 322 respectively. Conventionally, the oxygen generated by electrolyzing water will be discharged into the air; the generated oxygen does not used for other purposes, but the embodiment of the instant disclosure can keep the oxygen generated by electrolyzing water, so that the subsequent reaction can obtain more pure oxygen source. However, the pressure swing adsorption (PSA) oxygen generation unit 321 of the PSA oxygen generator 32 can obtains a large number of oxygen from the air; therefore, the instant disclosure does not limited whether the oxygen generated by the proton exchange membrane electrolysis unit 331 is stored to the oxygen storing unit 322 or not, for subsequent purposes.

Reference to FIG. 3B, FIG. 3B shows an experimental curve diagram of voltage versus current density of the fuel cell device according to an embodiment of the instant disclosure. When the oxidant source of the cathode of the fuel cell device 31 is obtained by replacing the air (which contains approximately 20% oxygen) into pure oxygen, the output current of the fuel cell device 31 can be obviously enhanced. For example, when the output voltage is 0.6 volts, the output current generated by supplying pure oxygen to the cathode than by supplying air to the cathode was increased by 63%. When the output voltage is 0.2 volts, the output current generated by supplying pure oxygen to the cathode than by supplying air to the cathode was increased by 115%. Please refer to the following descriptions for the detailed calculations about enhancing the power generation efficiency.

The following calculations is based on the situation by taking the oxygen generated from the PSA oxygen generator 32 as the oxidant source of the fuel cell device 31, when the fuel cell device 31 generates electrical power. To further understand the instant disclosure, the fuel cell device with 10 kilo-watt (kW) output power uses air and hydrogen as the oxidant and fuel source to operate for one minute is taken to illustrate and understand the calculation mechanism how to operate. Please assume that the fuel cell device is composed of 100 fuel cells (cell area=416 cm²) in series and each of fuel cells can generate 0.6 volts. At this time, the output current (density) of the fuel cell device is: 10,000 W/100 cells/0.6V=166.67 A=400 mA/cm²×416 cm². If the oxidant gas supplied for the cathode is exchanged to oxygen from air, the same stack of the fuel cell can generate 16.3 kW power (10 kW*(1+63%)). At this time, the output current of the fuel cell device is 271.67 amps (166.67×1.63). Theoretically, when each of fuel cells produced 1 A/cm² current density per minute, 3.5 c.c. would be consumed, it means that oxygen consumption is 3.5 cc/min. Therefore, the required volume of oxygen for the fuel cell device operating one minute can be calculated as follows:

$$271.67 A \times \frac{3.5 cc}{1 min . \times 1 cell \times A} \times 100 cell \times \frac{1 {m}^{3}}{1000000 cc} \times 1 min . = 0.095 {m}^{3}$$

From the above-mentioned procedures, the required volume of oxygen for the fuel cell device operating one minute is 0.095 m³. However, in practical applications, the required volume of oxygen for the fuel cell device may be the two times of the theoretical value. Therefore, the required volume of oxygen could be estimated to 0.19 m³ (0.095*2). According to the above descriptions, an extra 6.3 kW (16.3 kW−10 kW) power can be obtained by using pure oxygen (relative to air) to operate the above-mentioned reactions.

Additionally, when the pressure swing adsorption (PSA) oxygen generation unit 321 generates oxygen, each volume of one cubic meter oxygen (or called pure oxygen) needs to consume 318 kilowatts of power. In other words, in order to manufacture one cubic meter oxygen, the pressure swing adsorption (PSA) oxygen generation unit 321 needs to consume 0.318 kilowatts power, it means 0.318 kW/m³. According to the above calculations about the desired amount of oxygen, in order to manufacturer 0.19 m³ oxygen needs to consume 0.06 kW power (0.06 kW=0.19 m³*0.318 kW/m³). Subtract the electrical power for generating oxygen from the electrical power generated by the fuel cell device, and the total power of the net increase is 6.24 kW (6.3 kW−0.06 kW=6.24 kW). Therefore, it has a profit to use the pressure swing adsorption oxygen generation method to produce pure oxygen to supply for the fuel cell.

In other words, when pure oxygen is used as the oxidant source of the cathode of the fuel cell during the reaction of oxygen molecules (oxidant), the output power of the fuel cell can be effectively enhanced. After subtracting the electrical power consumed by the PSA oxygen generator from the increased output power generated by the fuel cell, the fuel cell still gets extra electrical power.

### Another Exemplary Embodiment of the Fuel Cell Power Generation System

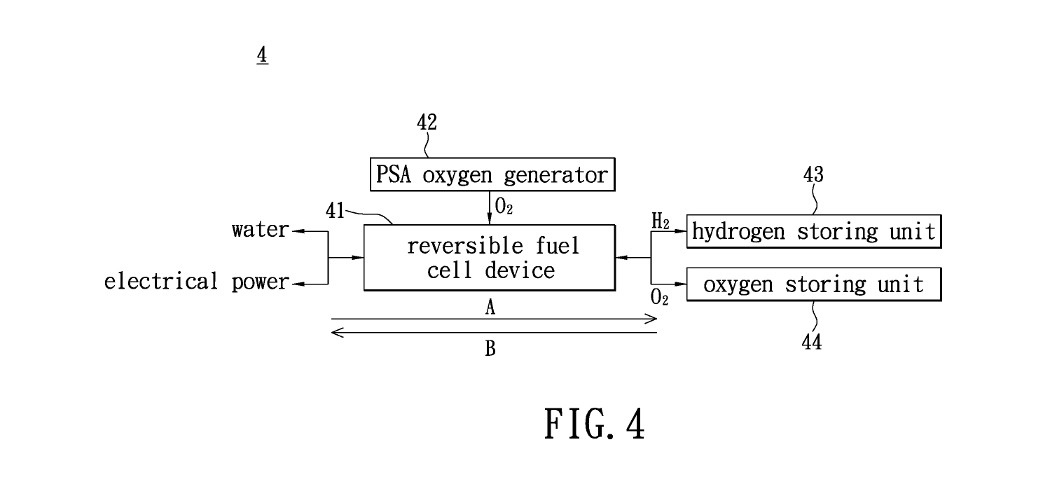

Reference to FIG. 4, FIG. 4 shows a block diagram of a reversible fuel cell power generation system according to another embodiment of the instant disclosure. The reversible fuel cell power generation system 4 or the electrical storing system 4 comprises a pressure swing adsorption (PSA) oxygen generator 42, a hydrogen storing unit 43, an oxygen storing unit 44 and a reversible fuel cell device 41. The reversible fuel cell device 41 can be a reversible proton exchange membrane fuel cell, a reversible alkaline fuel cell, a reversible phosphoric acid fuel cell, a reversible carbonate molten salt fuel cell, a solid oxide fuel cell, or any combination thereof.

The reversible fuel cell device 41 is connected to the pressure swing adsorption (PSA) oxygen generator 42, a hydrogen storing unit 43 and an oxygen storing unit 44. The pressure swing adsorption (PSA) oxygen generator 42 is used for generating oxygen. The reversible fuel cell device 41 can operate in a first mode (A) or a second mode (B). When the reversible fuel cell device 41 operates in the first mode (A), the reversible fuel cell device 41 receives the electrical power of the power source to electrolyze water in order to generate hydrogen (H₂), and stores the generated hydrogen in the hydrogen storing unit 43. When the reversible fuel cell device 41 operates in the second mode (B), the reversible fuel cell device 41 generates an electrical power by making the reaction of the oxygen generated from the PSA oxygen generator 42 or the oxygen storing unit 44 and the hydrogen generated from the hydrogen storing unit 43.

The reversible fuel cell device 41 can be connected to an external power source (not show in figures), such as an electricity grid system or other types of power source, to supply an electrical power to the electricity grid system or get an electrical power from the electricity grid system. For example, the reversible fuel cell device 41 (or the electrolysis device 41) is working in the electrolysis conditions, when the external power source is for off-electricity hours, the reversible fuel cell device 41 can operate in the first mode (A) and electrolyze water to generate hydrogen and oxygen, and converts the electrical power of the power source into hydrogen and stores the converted hydrogen to the hydrogen storing unit 43, and the oxygen generated by the reversible fuel cell device 41 can be stored in the oxygen storing unit 44. When the external power source is for peak electricity hours, the reversible fuel cell device 41 can operate in the second mode (B) and utilizes the electrical power generated by making the reaction of the oxygen and hydrogen, and then he reversible fuel cell device 41 supplies the generated electrical power to the external power source (like electricity grid system). It's worth mentioning the oxygen provided by the pressure swing adsorption (PSA) oxygen generator 42 can enhance the power generation efficiency of the reversible fuel cell device 41 when the reversible fuel cell device 41—generates electrical power (as the previous exemplary embodiment described). Therefore, compared to conventional fuel cells, the instant embodiment of the fuel cell power generation system 4 can obviously generate more electrical power when it generates electrical power.

According to the exemplary embodiment of the instant disclosure, the fuel cell power generation system uses the oxygen generated from the PSA oxygen generator to replace air, in order to effectively improve the output power of the fuel cell. Meanwhile, the enhanced output power of the fuel cell is greater than the power consumed by the PSA oxygen generator. In this way, the power generation efficiency of the fuel cell power generation system can be enhanced. Additionally, the reversible fuel cell can operate in two modes, one mode is for off-electricity hours to generate hydrogen (and oxygen) and the other mode is for peak electricity hours to generate electrical power.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A fuel cell power generation system, comprising:
a pressure swing adsorption (PSA) oxygen generator, generating the oxygen and having an oxygen storing unit to store the generated oxygen;
an electrolysis device, generating hydrogen and having a hydrogen storing unit to store the generated hydrogen;
a reformer device, generating hydrogen and having a hydrogen storing unit to store the generated hydrogen;
a fuel cell device, connected to the PSA oxygen generator and the electrolysis device, making the reaction of the oxygen generated by the PSA oxygen generator and the hydrogen generated by the hydrogen storing unit to generate electrical power.

2. The fuel cell power generation system according to claim 1, wherein the electrolysis device electrolyzes the water to generate hydrogen and stores the generated hydrogen to the hydrogen storing unit.

3. The fuel cell power generation system according to claim 1, wherein the reformer device catalyzes the hydrogencarbon species (ex. methanol, natural gas . . .) to generate hydrogen and stores the generated hydrogen to the hydrogen storing unit.

4. The fuel cell power generation system according to claim 1, wherein the electrolysis device electrolysis the water to generate oxygen and stores the generated oxygen to the oxygen storing unit.

5. The fuel cell power generation system according to claim 1, wherein the electrolysis device utilizes proton exchange membrane water electrolysis, alkaline electrolysis, phosphoric acid electrolysis, carbonate molten salt electrolysis, solid oxide electrolysis, or any combination thereof

6. A fuel cell power generation system, comprising:
a pressure swing adsorption (PSA) oxygen generator, generating the oxygen;
a hydrogen storing unit;
an oxygen storing unit;
a reversible fuel cell device, connected to the PSA oxygen generator, the hydrogen storing unit and the oxygen storing unit, wherein the reversible fuel cell device operates in a first mode or a second mode, when the reversible fuel cell device operates in the first mode, the reversible fuel cell device receives electrical power of a power source to electrolyze water to generate hydrogen, and stores the generated hydrogen in the hydrogen storing unit, when the reversible fuel cell device operates in the second mode, the reversible fuel cell device generates electrical power by making the reaction of the oxygen generated from the PSA oxygen generator or the oxygen storing unit and the hydrogen generated from the hydrogen storing unit.

7. The fuel cell power generation system according to claim 6, wherein the reversible fuel cell device has an electrolysis device (proton exchange membrane), water is the fuel of the electrolysis device, the electrolysis device receives the electrical power of the power source to electrolyze the water, generating the oxygen and storing the generated oxygen in the oxygen storing unit.

8. The fuel cell power generation system according to claim 6, wherein the PSA oxygen generator connected to the oxygen storing unit, storing the oxygen generated by the PSA oxygen generator to the oxygen storing unit.

9. The fuel cell power generation system according to claim 6, wherein the reversible fuel cell device is a reversible proton exchange membrane fuel cell device, an reversible alkaline fuel cell device, a reversible phosphoric acid fuel cell device, a reversible carbonate molten salt fuel cell device, a reversible solid oxide fuel cell device, or any combination thereof

10. The fuel cell power generation system according to claim 6, wherein the first mode is for off-electricity hours, the first mode converts the power of the power source into hydrogen and stores the converted hydrogen to the hydrogen storing unit.

11. The fuel cell power generation system according to claim 6, wherein the second mode is for peak electricity hours, the second mode makes the reaction of the oxygen generated from the PSA oxygen generator or the oxygen storing unit and the hydrogen generated from the hydrogen storing unit to generate electrical power and provides the generated electrical power to the power source.
